(19) United States
(12) Patent Application Publication
(10) Pub. No.: US 2016/0300406 A1
(43) Pub. Date: Oct. 13, 2016

(54) Method and system for vehicle body inspection

(71) Applicants: Versan Bora Hamamcioglu, Miami, FL (US); Guy Ravitz, Miami, FL (US)

(72) Inventors: Versan Bora Hamamcioglu, Miami, FL (US); Guy Ravitz, Miami, FL (US)

(21) Appl. No.: 14/789,002

(22) Filed: Jul. 1, 2015

Related U.S. Application Data
(60) Provisional application No. 62/146,267, filed on Apr. 11, 2015.

(51) Int. Cl. G07C 5/08; G06F 3/0481; G06F 3/0488; G06F 3/0484

(52) U.S. Cl. CPC G07C 5/08; G06F 3/04842; G06F 3/04817; G06F 3/0488

(57) ABSTRACT

A system and method for vehicle body inspection provided by a mobile device including a set of instructions to indicate the damaged area of the vehicle by tapping a vehicle representation (chart) at said mobile device while the customer walks around the vehicle.

### STATEMENT REGARDING FEDERALLY SPONSORED RESEARCH AND DEVELOPMENT

N/A

### RELATED APPLICATIONS

This application claims the benefit of priority of U.S. provisional application 62/146,267, filed on Apr. 11, 2015

### BACKGROUND OF THE DISCLOSURE

1. Technical Field

The present disclosure is directed to a system and method for vehicle body inspection provided by a mobile device including a set of instructions to indicate the damaged area of the vehicle by tapping a vehicle representation (chart) at said mobile device while the customer walks around the vehicle.

2. Discussion of the Background

Inspections are routinely carried out on many items including mobile machines that transport people or cargo, houses and more. Sometimes even people are inspected for wounds, for example in vehicle accidents. In all cases a person wants to inspect and annotate observations.

For example, when renting a vehicle typically the customer/renter selects a vehicle; then makes the request to the vehicle owner. Once the vehicle owner accepts the request both parties (customer and vehicle owner) meet up for vehicle's inspection. The customer renting the vehicle is asked to perform a visual inspection of the condition of the vehicle and affirm it by signature and a customer service representative or vehicle owner often must note damage both before and after the customer drives the vehicle. During the inspection the vehicle owner and customer walk around the vehicle to mark any pre-existing damages on a piece of paper with the illustration of the vehicle. The experience is similar to shipping a vehicle when the owner and the sales representative fill out an inspection form and mark damages on a piece of paper with the illustration of the vehicle (circles for scratches, cross for dents etc.). Defects of this nature must be located, observed and recorded via a manual process which might get lost and/or add additional manual labor because is not properly recorded. At present, although some may be electronic, most are still recorded on paper and stored in files. Therefore there is a need to avoid paper files that may be located in many different places and make it hard to track the history of the condition of a vehicle.

The present disclosure is directed to overcoming the one or more problems or disadvantages associated with the prior art and to provide a more efficient, easy, and precise system that indicates conditions of interest on a vehicle body.

### SUMMARY OF THE DISCLOSURE

The present disclosure is directed toward an interactive process for vehicle inspection that is accessible through the mobile device. In accordance with the principle of the present disclosure both, renter and vehicle owner, have the ability to document a walkthrough or walk-around of the vehicle's exteriors. The mobile device comprises a display with a chart representing the vehicle. The chart representing the vehicle will be mapped to a 2 dimensional grid where each cell of the grid will represent a general location on the vehicle. The resolution of the grid may vary, however a multi-dimensional data model representing the damages grid will be stored in the database recording the different type of damages as per user's input. Whenever a user identifies damage he/she will tap the mobile device, more particularly the display on the mobile device that indicates the area on the vehicle chart where he/she believes the damage is located or whether if the damage is a scratch or dent. A visual representation of the damage will be displayed on the vehicle chart and the location and type of damage will be stored in a data object which will be stored in a database. Using the users' ids and transaction id, the walk around data will always be associated with the specific transaction and will be available for retrieval from the database at all time.

Another object of the present disclosure is to provide a system and method with the integration of a near field technology (or beacon technology) to validate that the walk through (or walk-around) is performed by both renter and vehicle owner at the same time and same place.

Another object of the present disclosure is to provide a system and method that allow users to take photos of damages and have them associated with the location on the vehicle chart.

Another object of the present disclosure is to provide a system and method for using the mobile device's sensors (i.e. gyroscope) to calculate the user's location in relationship to the vehicle during the walk through which will enable the mobile device to automatically detect the location where a damage needs to be recorded from without needing the user to select the location on the chart.

The invention itself, both as to its configuration and its mode of operation will be best understood, and additional objects and advantages thereof will become apparent, by the following detailed description of a preferred embodiment taken in conjunction with the accompanying drawing.

The Applicant hereby asserts, that the disclosure of the present application may include more than one invention, and, in the event that there is more than one invention, that these inventions may be patentable and non-obvious one with respect to the other.

### BRIEF DESCRIPTION OF THE DRAWINGS

The accompanying drawings, which are incorporated herein, constitute part of the specifications and illustrate the preferred embodiment of the disclosure.

FIG. 1 is an exemplary general illustration of the system for vehicle body inspection in accordance to the principles of the current disclosure.

FIG. 2 illustrates the overall setup of the system that supports the walk-around process in accordance to the principles of the current disclosure.

FIG. 3 is a flowchart of an exemplary disclosed system and method for the inspection walk-around process in accordance to the principles of the current disclosure.

FIG. 4 is an exemplary general illustration of the data base for the system for vehicle body inspection in accordance to the principles of the current disclosure.

FIG. 5 is a flowchart of an exemplary disclosed system and method for the display existing damage data sub-process in accordance to the principles of the current disclosure.

FIG. 6 is a flowchart of an exemplary disclosed system and method for the record damage sub process in accordance to the principles of the current disclosure.

FIG. 7 is a flowchart of an exemplary disclosed system and method for the delete damage sub process in accordance to the principles of the current disclosure.

FIG. 8 is an exemplary illustration of a graphical interactive user interface in accordance to the principles of the current disclosure.

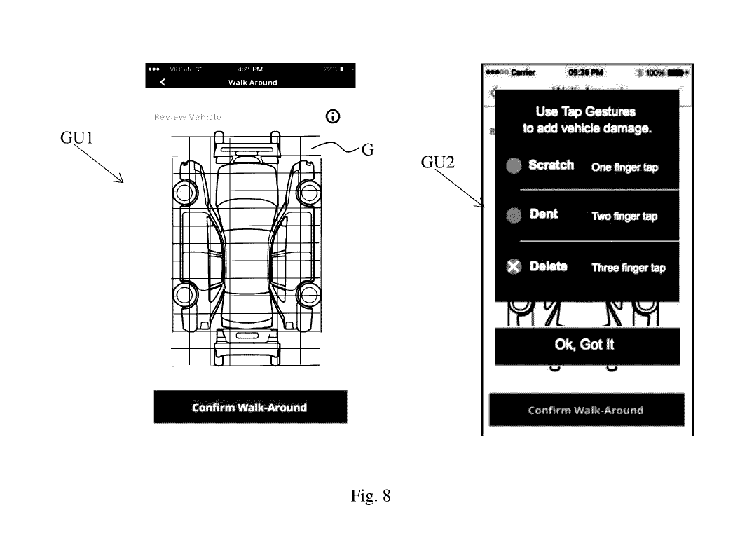

FIG. 9 is a flowchart of an exemplary disclosed system and method for the walk-around process with location tracking in accordance to the principles of the current disclosure.

FIG. 10 is a flowchart of an exemplary disclosed system and method for the initialize grid process in accordance to the principles of the current disclosure.

FIG. 11 is a flowchart of an exemplary disclosed system and method for the storage of damage information with automatic location tracking in accordance to the principles of the current disclosure.

FIG. 12 illustrates the overall setup of the system that supports the walk-around process with tracking in accordance to the principles of the current disclosure.

FIG. 13 is a flowchart of an exemplary disclosed system and method for the damage photo taking process in accordance to the principles of the current disclosure.

FIG. 14 is a flowchart of an exemplary disclosed system and method for the walk-around process including location tracking and NFC/Beacon for walk-around approval in accordance to the principles of the current disclosure.

### DETAILED DESCRIPTION

The embodiments of the invention disclosed herein may be implemented, through the use of general-programming languages (such as C or C++). The program code can be disposed in any known computer-readable medium including semiconductor, magnetic disk, or optical disk (such as CD-ROM, DVD-ROM). As such, the code can be transmitted over communication networks including the Internet.

In the present disclosure, the terms “computer program medium” and “computer-usable medium” are used to generally refer to media such as a removable storage unit or a hard disk drive. Computer program medium and computer-usable medium can also refer to memories, such as system memory and graphics memory which can be memory semiconductors (e.g., DRAMs, etc.). These products are examples of how to provide software to a computer system.

The embodiments are also directed to computer products, such as a mobile device, comprising software stored on any computer-usable medium. Such software, when executed in one or more data processing devices, causes a data processing device(s) to operate as described herein or, allows for the synthesis and/or manufacture of computing devices (e.g., ASICs, or processors) to perform embodiments described herein. Embodiments employ any computer-usable or -readable medium, and any computer-usable or -readable storage medium known now or in the future. Examples of computer-usable or computer-readable mediums may include, but are not limited to, primary storage devices (e.g., any type of random access memory or read-only memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

For purposes of this discussion, the term “module” may include at least one of software, firmware, and hardware (such as one or more circuits, microchips, or devices, or any combination thereof), and any combination thereof. In addition, it will be understood that each module may include one or more components within an actual device, and each component that forms a part of the described module can function either cooperatively or independently of any other component forming a part of the module. Further a module may comprise a set of instruction of a sub-program, wherein said sub-program is composed of one or more independently developed modules that are linked to a more complex program. A single module may contain one or several routines. Conversely, multiple modules described herein may represent a single component within an actual device. Further, components within a module may be in a single device or distributed among multiple devices in a wired or wireless manner.

The present disclosure is directed toward an interactive process for vehicle inspection that is accessible through at least a first unit module and/or second unit module, such as a mobile device. Each mobile device comprising an operative system, an image acquisition C1, C2, a motion detention sensors S1, S2, a display unit, a computer-readable medium and a computer-usable medium, wherein said mobile device comprises a platform interface 21, 31 coupled by means of a communication medium to a server and/or computing platform. The server comprises at least a data a second computer-readable medium and a second computer-usable medium, wherein said server is in communication with a data base 11.

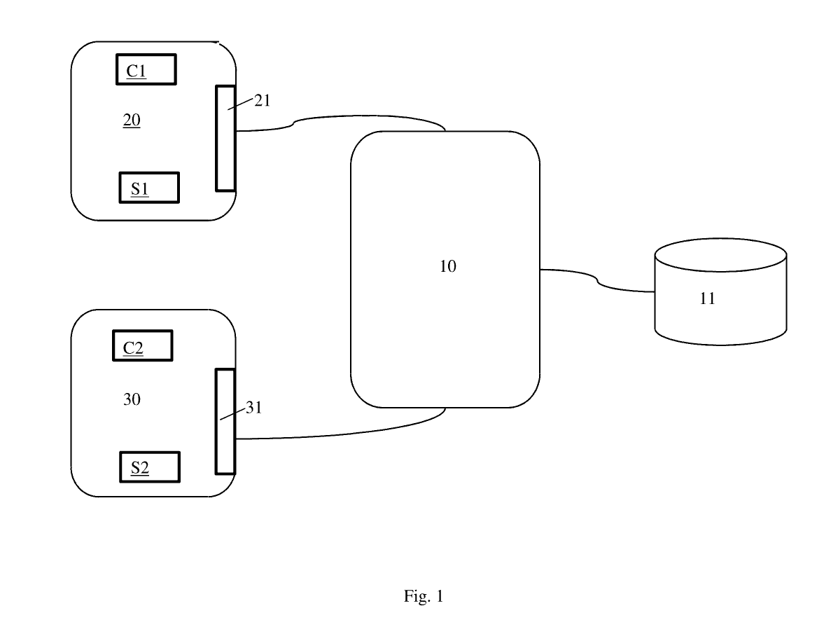

FIG. 1 illustrates a system for vehicle body inspection 100. The general system for vehicle body inspection 100 may include a first unit module 20, a second unit module 30, and a computing platform 10. The computing platform 10 may include or may be otherwise operatively coupled to a database 11, which may be stored in a memory. Database 11 may include more than one database or another type of electronic repository. Computing platform 10 may include the software functionality and hardware capabilities to implement data sharing strategies through and between the first unit module 20, the second unit module 30 and to access, read, and write the database 11. As shown first unit module 20, a second unit module 30, are coupled to said computing platform 10 by means of a communication medium.

In accordance with the principles of the current disclosure a first item owner supplying a first item V, such as a vehicle, interacts with a customer looking to rent said vehicle V, by providing a system that indicates the damaged area of the vehicle V, wherein the identification of damages is accomplished by physically interacting with at least a first unit module 20. In accordance with the process of the identification of damages the first unit module 20 comprises at least a set of instructions and a display which assists with the identification of the first item damages. Further the first unit module 20, in communication with a platform 10, is configured to physically interact with the customer C and/or owner 0, wherein the physical interaction includes, but is not limit to, tapping the display of the first unit module 20. FIGS. 1 through FIG. 5 are directed to the modules for the process of “tapping fingers to point out damage”. The same process will be repeated when both parties meet up at the end of the rental session. The purpose of the final walk-around is to make sure that there aren't any new damages to the vehicle resulting from the session.

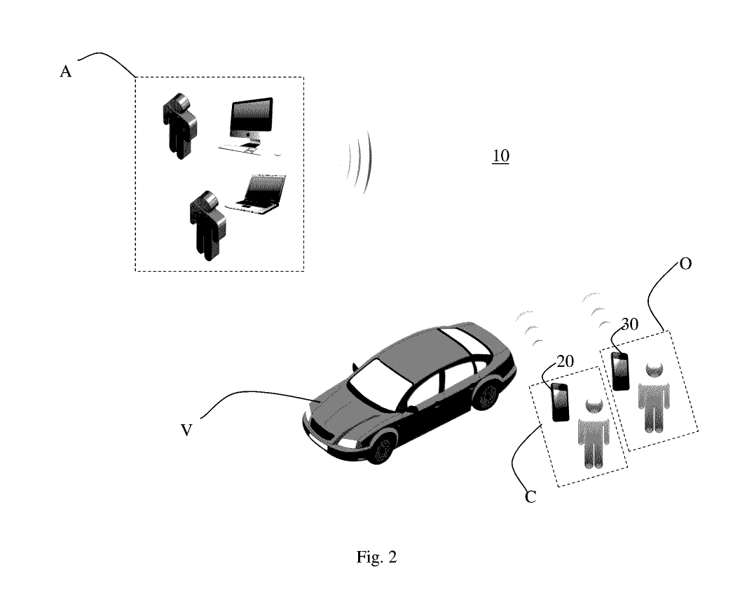

As shown in FIG. 2 a first user C comprising a first module unit 20 and second user 0 comprising a second module unit 30 interact with the system through the communication medium between the platform 10 and said first module unit 20 and/or said second module unit 30. Several set of instructions, as describe below, stored at the computer-readable medium of said first module unit 20 and on the computer-readable medium of said second module unit 30 assists the connection with said platform 10. The interaction between the first module unit 20, the second module unit 30 and the platform promotes retrieving the data in order to perform the walk-around process and store the resulting data provided by the users for the purpose of recording the vehicle damage information entered by the users for each transaction. The platform also provides processing support to the first module unit 20 and the second module unit 30 when necessary.

Further, as shown in FIG. 2, a third party A may view, control, manage or administrate the information at the platform 10 that was entered for each specific transaction recorded in the database. This gives the third party A the ability to review damage information entered at the beginning and end of each transaction in case there are any disputes between the second user O and the first user C about the damages of the vehicle involved in the transaction. The dotted line in FIG. 2 illustrates that the second user O, the first user C and third party A may be in a different physical location than the third party A and their respective terminals.

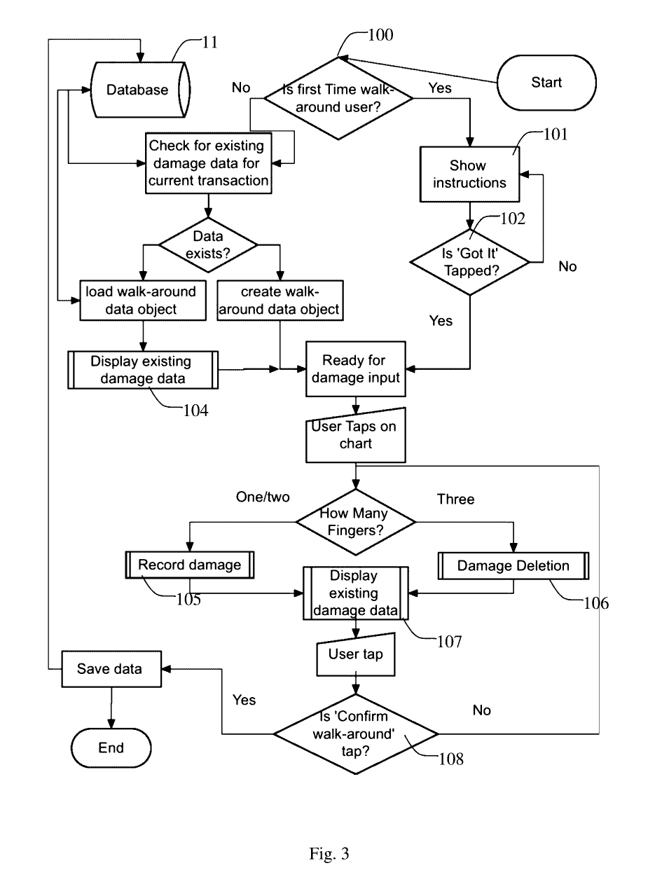

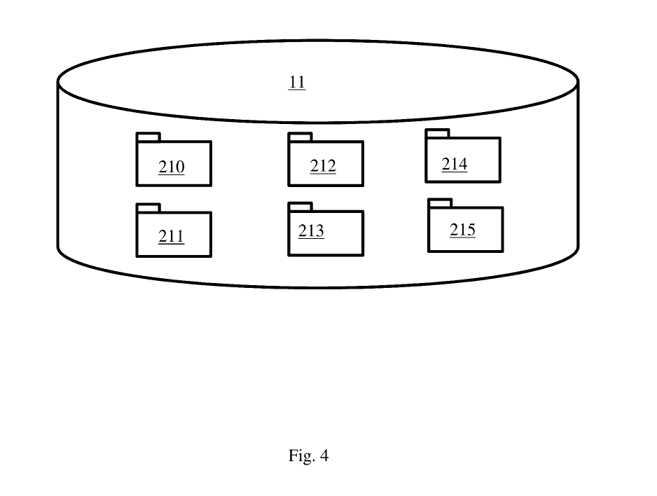

As mentioned above, the physical interaction with the first module unit 20 and/or second module unit 30 is accomplished by tapping on the display of the respective module unit. FIG. 3 describes the overall flow of the tapping fingers to point out damage process. First the set of instructions at the module units in communication with the platform will check if the user had ever performed 100 a walk-around the vehicle V. If this is the user's first time performing a walk-around using the system a short animated tutorial 101 will be presented to the user. Once the user confirms 102 he/she is clear on how to perform the process and after the selection of the vehicle model, the user is presented with the two-dimensional vehicle chart so he/she can start the process. The chart representing the vehicle is mapped to a 2 dimensional grid wherein each cell of the grid will represent a general location on the vehicle to be rent. The resolution of the grid may vary, however a multi-dimensional data model representing the damages grid will be stored in the database recording the different type of damages. The data base 11, as shown in FIG. 4, provides several folders 210-215 with different types of vehicle modules chart designs wherein the number of grids may vary depending on the vehicle model. In case the system detects that this user performed a walk-around before, it next checks with the database 11 whether there is already walk-around data associated with the current transaction. A transaction involves one vehicle and two users namely a renter/first user C and a vehicle owner/second user O. If data already exists for the current transaction it is loaded and displayed on the screen of the appropriate user module unit using the “Display existing damage data” 104 enabling him/her to complete the walk-around process. As seen in FIG. 3 once all required checks and setups are completed the systems waits for the user to tap the two-dimensional vehicle chart to start recording damages data. When a user taps the screen/display the module unit detects the location on the screen/display that was tapped. If the user tapped once or twice, the systems directs to the “Record Damage” process 105 (which is described below). If the user tapped 3 times then the app directs the user to the “Damage Deletion” process 106 (which is described below). Once the user completes either the “Record Damage” process 105 or the “Damage Deletion” process 106, the next step is the “Display existing damage data” process 107 which updates the display based on the most recent user interaction. After the display has been updated with the most recent data, the system waits for the next user input. If the user taps the “Confirm walk-around” button 108 then the data is saved and the process complete. Otherwise the process goes through another iteration of the process of either recording or deleting damages.

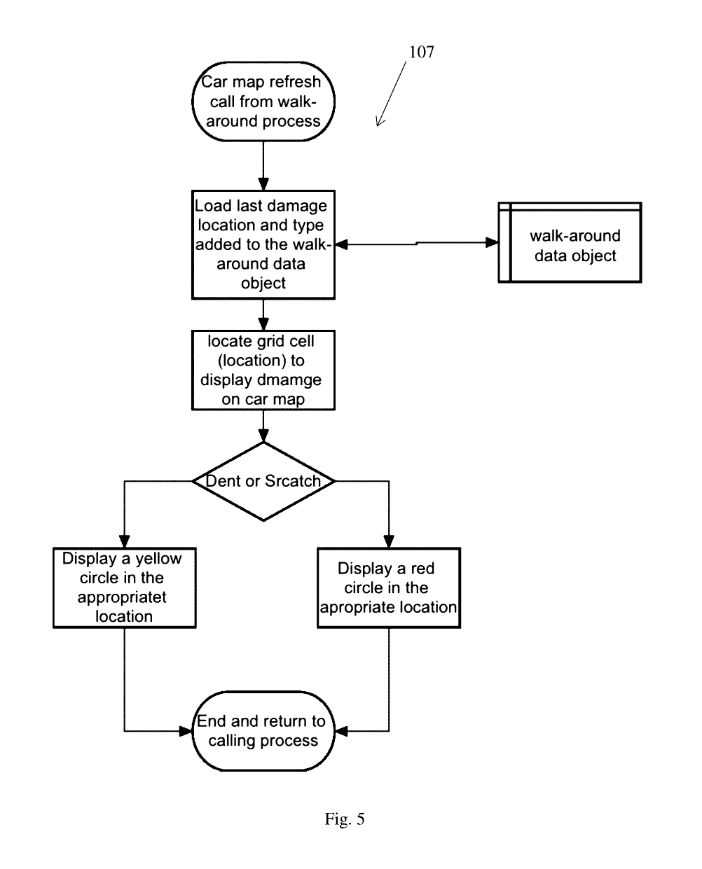

FIG. 5 describes in more details the “Display existing damage data” sub process 107. What initiates this process is a refresh call from the main walk-around process. This sub process loads the location and type of damage from the walk-around object. Next the system will locate the location on the grid representing the loaded damage, and will display a first indicia, such as a yellow dot, in case the damage is of “scratch type” and a second indicia different from the first indicia, such as a red dot, for a “dent” damage type. Once the damage is displayed on the two-dimensional vehicle map this sub process is complete and takes the user back to the main walk-around process.

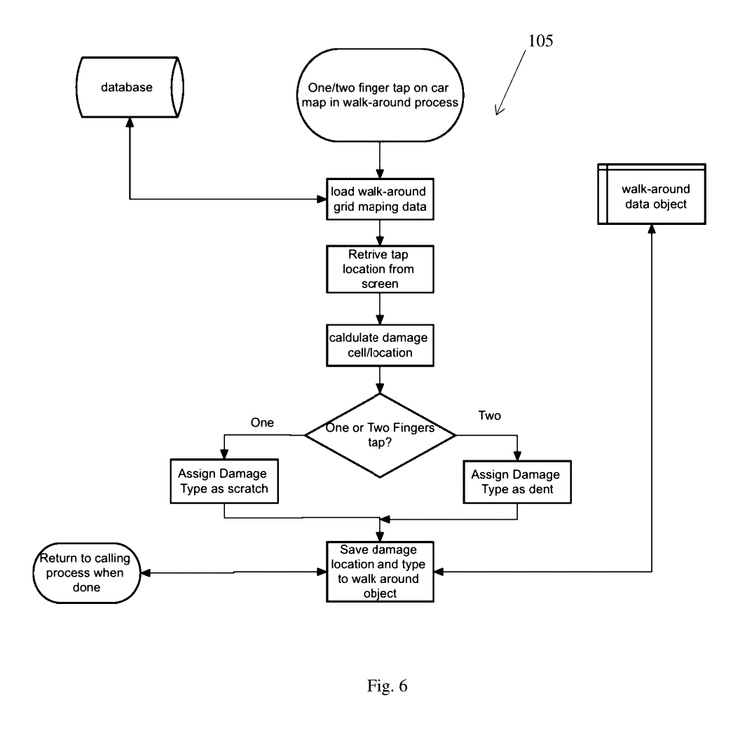

FIG. 6 illustrates the flow of the “Record damage” sub process 105. This process is triggered each time a one or two finger taps is detected during the input ready stage of the main walk-around process. First this sub-process will load the walk-around grid mapping data from the database 11. This grid mapping data will enable the system 100 to map the tapped location on the screen to the proper cell for data storage and displaying purposes. Next the user's tap location is calculated and mapped to the right cell, and based on the number of taps the damage gets assigned a damage type of scratch for one tap and dent for two taps. Next the damage location (cell) and damage type are stored to the walk-around data object. Once data is saved the system returns to the calling parent process.

FIG. 6 illustrates the “Delete damage” sub process 106. This process is triggered each time three finger taps are detected during the input ready stage of the main walk-around process. First the system will confirm that the user wants to delete the last entered damage in the tapped cell. Cancel response will send the user back to the main process without doing anything. If the user confirms the deletion, the app will retrieve the identifier of the selected damage and remove the proper item form the walk-around object. Next the display will be updated and the app will return to the main process.

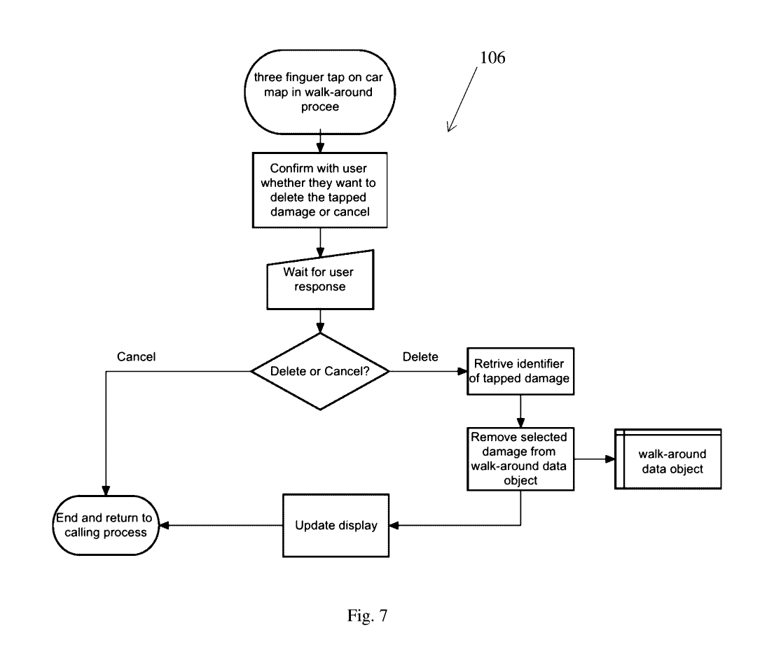

FIG. 7 illustrates the current proposed user interfaces GU1, GU2 to be used to implement the walk-around process. The first graphic unit interface GU1 on the left of FIG. 5, illustrates the two-dimensional vehicle map comprising a grid with cells G and the confirm button used to end the walk around process. The second graphic unit interface GU2 on the right of FIG. 5, shows the animated instruction that will be displayed for users that are about to perform the walk-around process for the first time.

As disclosed above, the present disclosure is intended to provide a system 100 for a first user C and a second user O to have the ability to document a walkthrough of the vehicle's exteriors as explained above on FIG. 2 and FIG. 3. The module unit comprises a display with a chart representing the vehicle as explained above in FIG. 7. The chart representing the vehicle will be mapped to a 2 dimensional grid where each cell G of the grid will represent a general location on the vehicle. The resolution of the grid may vary, however a multi-dimensional data model representing the damages grid will be stored in the database recording the different type of damages as per user's input. Whenever a user identifies damage he/she will tap the mobile device, more particularly the display on the mobile device and indicates the area on the vehicle chart where he/she believes the damage is located or whether if the damage is a scratch or dent as explained in FIG. 3 through FIG. 6. The users will add a scratch by one finger tap and add a dent by two-finger tap. The users will be able to delete a scratch or dent by tapping the area three times. A visual representation of the damage will be displayed on the vehicle chart and the location and type of damage will be stored in a data object which will be stored in a database 11. Using the users' ids and transaction id, the walk around data will always be associated with the specific transaction and will be available for retrieval from the database at all time. The present feature minimizes damage claims as both parties will have proof of the vehicle's condition pre and post rental.

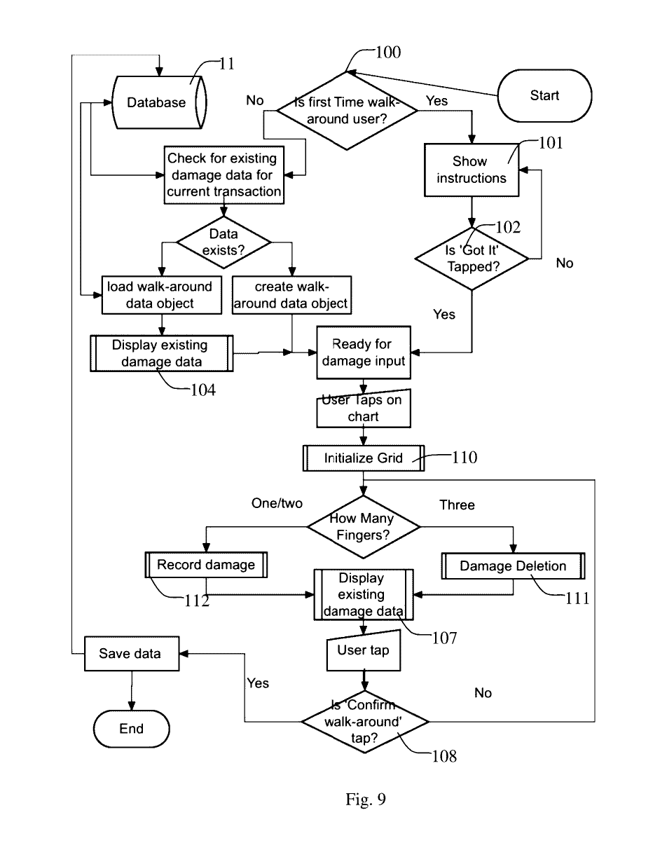

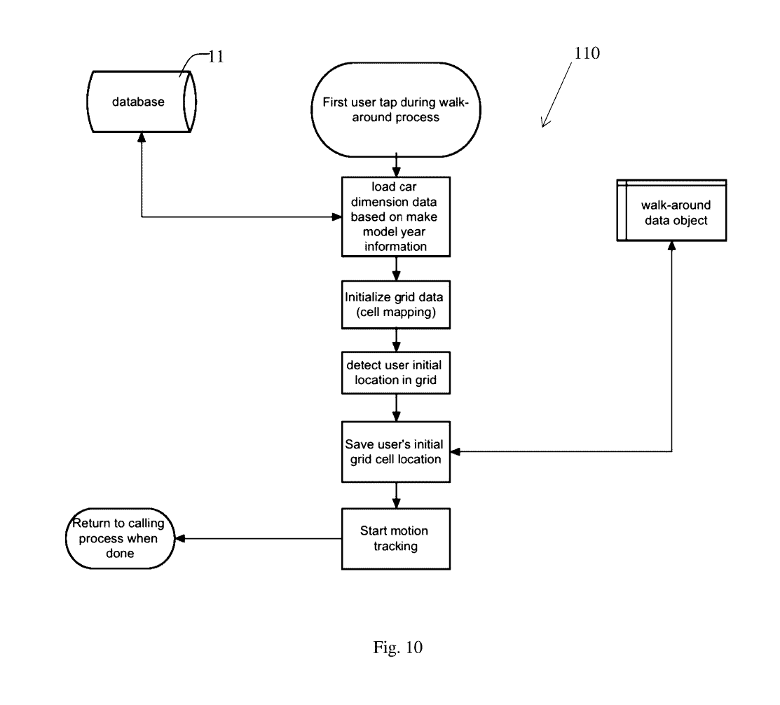

The present disclosure also provides a system and method that allow users to take photos of damages and have them associated with the location on the vehicle chart. In order to associate the location with the damage the system calculates the user's location in relationship to the vehicle. The system uses the mobile device's motion detection hardware components such as the gyroscope, accelerometer, and compass to calculate the user's location in relationship to the vehicle during the walk-around process as shown in FIG. 9 and FIG. 10. This will enable the system to automatically detect the location where damage needs to be recorded from without needing the user to select the location on the chart. The system will also allow users to take photos of damages and have them associated with the location on the vehicle chart.

The first user C or second user O will be required to initiate the process by letting the system know where he/she is physically located with respect to the vehicle. The user will do this by tapping the vehicle chart on the proper location representing his/hers location with relation to the vehicle. The user will also be required to have the module in his/hers hands and facing the vehicle throughout the walk-around process.

The system will then track the user's motion as he/she is walking around the vehicle and will use the motion detectors readings along with known knowledge of the vehicle's dimensions (using the make, model, year information for the specific vehicle) to determine automatically which grid cell G to associate with each recorded damage as shown in flow chart FIG. 10. This will result in indicating the damage's estimated location without requiring the user to tap the proper location on the vehicle chart.

This could be used in conjunction with the tapping mechanism described in FIG. 3 through FIG. 7, or as an improved stand-alone version of the walk-around process. The present feature simplified process which will save the user the need of trying to determine the proper area of the vehicle chart he/she is supposed to tap in order to record damage. This process is also used to reduce data entry errors.

FIG. 9 illustrates the flow of the overall walk-around process with the location tracking feature. The overall walk-around process is the same as in the “tapping fingers to point out damage” which was previously described. The difference here is the additional “Initialize Grid” process 110 and the “Record Damage” and “Damage Deletion” sub processes. We will discuss these in more details below. Once the initial checks and setups are performed and all necessary data is loaded, as before, the system is ready for user input.

In the case of walk-around with location tracking, the first tap on the two-dimensional vehicle map, initiates the “Initialize Grid” sub-process 110, which is described in FIG. 10. The first step on the initialization process is to load the dimensions data based on the make, model and year of the vehicle which is a part of the current transaction. This information is loaded from our database 11 and is going to be used to calculate the user's location in relation to the vehicle as the user walks around the vehicle. Next the cell mapping is performed based on the grid resolution settings in the database 11. The user's initial location in relation to the grid is detected based on the area of the first tap which is required to start the walk-around process, as we need to collect the first point of reference of the user's location in relation to the vehicle to start the tracking. This location is stored in our modified walk-around data object. At this point the motion tracking process has started and will run in the background while the user performs the walk-around process.

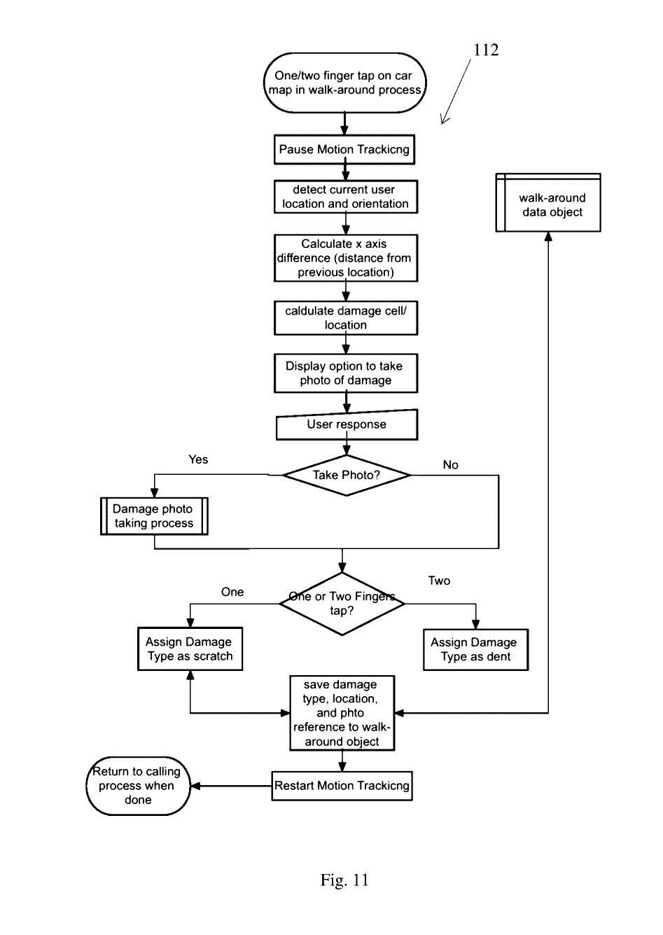

FIG. 11 illustrates the flow of the modified “Record Damage” sub-process 112 when the motion tracking feature is enabled. As disclosed in FIG. 6, this sub-process is called for by either a one or a two finger tap on the two dimensional vehicle map during the “ready for damage input” stage of the main process and after the “Initialize Grid” sub-process 110 is complete. The first step of the “Record Damage” sub-process described in FIG. 11 is to pause the motion tracking process and retrieve the current location and orientation of the user's module unit. Next the x axis difference between the current location and the user's previous location is calculated, which results in automatically detecting the estimated location of the user in relation to the vehicle. Based on the user's location, the app will determine the cell in the vehicle map grid to which the added damage should be associated. Another enhancement of the walk-around feature described in this section over the previous section is the ability to add photos to be associated with each damage in the data object and eventually in the database 11. Next, the damage type is determined and all the information that has been collected and calculated during this sub-process, including, damage location, type, and photo reference are all stored in the walk-around object. Once all data is stored, the tracking process is started again and this sub-process ends which enables the user to continue the walk-around process for the rest of the vehicle.

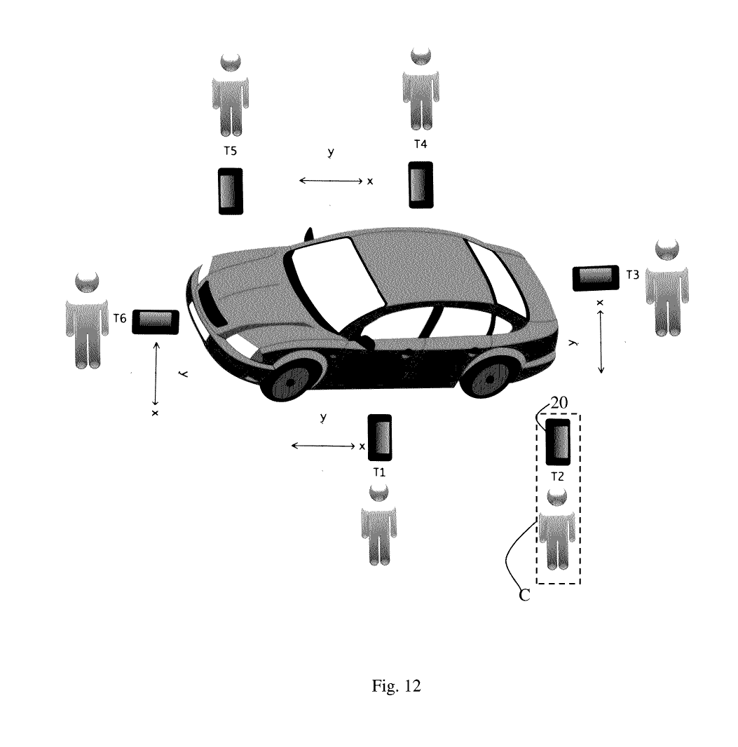

FIG. 12 illustrates a physical example of the walk-around process with the tracking feature enables as described in FIG. 9 through FIG. 11. The user and respective module unit are presented in relationship to the vehicle's location throughout this walk-around process. The locations sequence in this example are represented by the letter T following by a numerical value where T1 represents the first tap (initial location where location tracking starts) and T6 represent the final location. As can be seen in this FIG. 12, the user must point the module unit towards the vehicle at all time (screen facing the user, and back of the module unit facing the vehicle). The x-axis is always considered to be parallel to the vehicle itself. Our algorithm uses the horizontal difference in location (x axis difference) at each tap incident to estimate the user's location in relation to the vehicle. The arrows in FIG. 12 indicate the direction or path that the user might take during the walk-around process. User can go in a clockwise direction or counter clockwise direction at any time during this process as indicated by the two directional arrows.

In this example we represent one user, but the scenarios possible here are for either first user, second user or both to be performing the process at the same time. Each user's location and data input will be stored separately in our database for each transaction so this data can be later used to verify and compare damage information for each vehicle and each transaction. Please note that this could also be viewed as an example for the walk-around process as discussed in FIG. 3 though FIG. 7, at which case the requirement for the user's phone to point at the vehicle at all times is ignored.

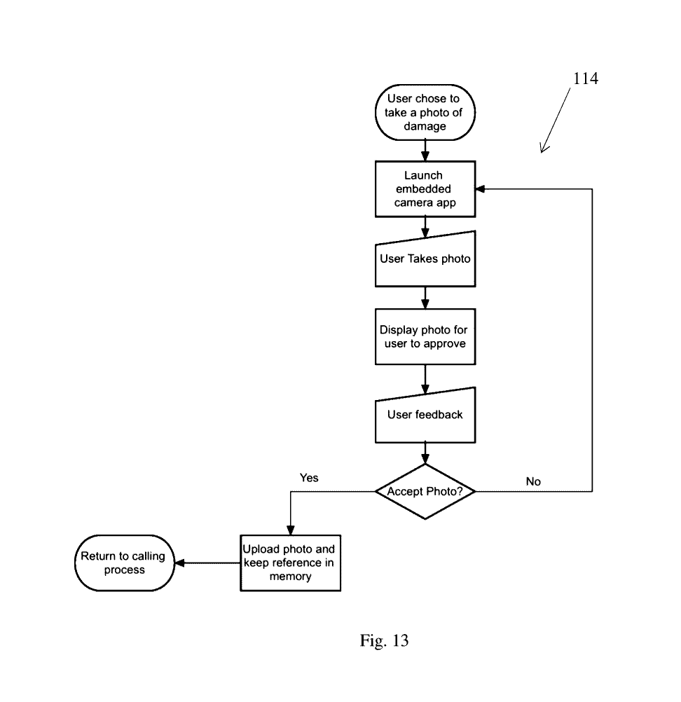

FIG. 13 describes the flow of the “Damage photo taking” sub-process 114. This process is initiated in the “Record Damage” sub-process shown in FIG. 11, if a user decides to add a photo to a recorded damage. The sub-process illustrated in FIG. 9 begins by launching an embedded camera interface which lets the user to take a photo of the damage and associate it to the current recorded damage. The user can take the photo as many times as he/she would like until a preferred photo is approved. Once approving the photo, the photo is uploaded to our database 11 and a reference is kept to be stored in the walk-around data object once the calling process is done. The rest of the functionalities of the walk-around process described in this section are the same as the one's of the process described in FIG. 1 through FIG. 7.

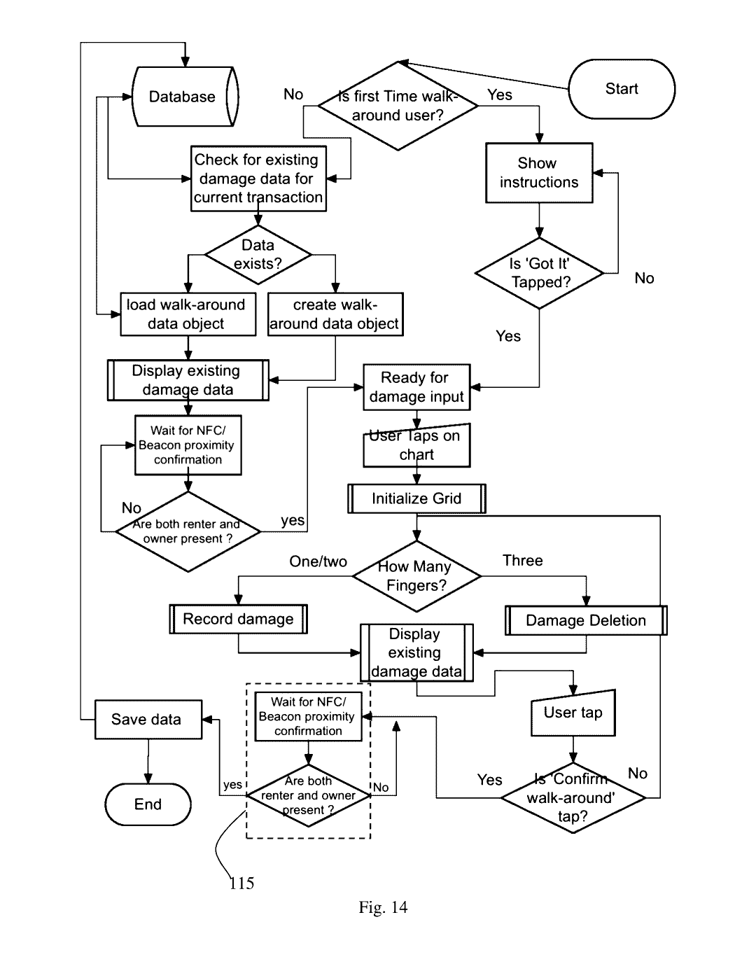

The system, as mentioned above, comprises that each mobile device includes an integrate close distance data transmitter, such as near field technology (also called beacon Technology) to validate that both first user and second user performed the walk-around at the same time and same place as explained in FIG. 14. Near field communication (NFC) establishes radio communication with each other at a close distance. For example by touching them together or bringing them into proximity, typically a distance of 10 cm (3.9 in) or less confirmation data may be shared between the first user C and second user O. The present feature eliminates false claims that have been submitted without the other party being present.

FIG. 14 illustrates the walk-around process with both tracking functionality and our last enhancement, the “Near field technology” feature. FIG. 14 includes all the processes and shows the same flow of both FIGS. 3 and 9. The only addition in FIG. 14 is the very last stage which is intended to verify that both users, first user C and second user O, are present at the time of the current walk-around process. This will provide us another way of ensuring and conforming that both users are present during the process of the walk-around. A simple module unit bump or user walk-around completion confirmation on the system will initiate a process that will use near field technology to acknowledge user's location and transfer acknowledgement data between the users.

For instance, a customer that scratched the rented vehicle during the rental period will not be able to complete the walk-around by himself and skip adding the new scratch. The “Near field technology/Damage location” 115 will ensure that both parties validate the submitted damages to prevent future claims and misunderstandings. Validation can be added as a requirement to both start and complete the walk-around process.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, it is contemplated that these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed for this purpose.

It will be apparent to those skilled in the art that various modifications and variations can be made to the method and system described in the present disclosure. Other embodiments of the method and system will be apparent to those skilled in the art upon consideration of the specification and practice of the methods and systems disclosed herein. It is intended that the specification and examples be considered as exemplary only, with a true scope of the disclosure.

1. A method for enabling inspection of a vehicle, comprising:
a first user with a first unit module, wherein said first unit module comprises a first computer medium, a first display and first motion detection sensor;
a second user with a second unit module, wherein said second unit module comprises a second computer medium, a second display and second motion detection sensor;
a platform comprising a data base; wherein said data base comprises a list of items and an item representation of each item;
retrieving into the first unit module item representation corresponding to a selected item;
displaying at the first display an interactive graphical representation of the item;
retrieving into the second unit module item representation corresponding to said selected item;
displaying at the second display the interactive graphical representation of the item;
said first user with said first unit module identifying selected item structural status by physically interacting with the interactive graphical representation by providing a first distinctive physical action;
transferring to said platform the identified selected item structural status by the first user after providing a particular number of times a first distinctive physical action;
said second user with said second unit module confirming selected item structural status by physically interacting with the interactive graphical representation by providing a particular number of times a second distinctive physical action;
transferring to said platform the confirmed selected item structural status by the second user after providing said second distinctive physical action; and
said platform comparing the identified selected item structural status with said confirmed selected item structural status by the second.

2. The method as in claim 1, wherein the item is a vehicle.

3. The method as in claim 1, wherein the item representation is a two-dimensional view of the item divided in a grid, wherein said grid comprises a plurality of cells.

4. The method as in claim 3, wherein the first distinctive physical action is tapping on said display, wherein the number of times tapping on a limited area represents a first particular value; and wherein said first particular value on said limited area is associated to a particular cell from said plurality of cells.

5. The method as in claim 4, wherein said particular value is selected from scratch, dent or delete.

6. The method as in claim 5, wherein said particular value is validated.

7. The method as in claim 3, further comprising: identifying a first point of reference, wherein the first point of reference is the first user initial location in relation to said grid, wherein said initial location is provided by a third distinctive physical action on a first cell from said plurality of cells.

8. The method as in claim 7, further comprising: identifying selected item structural status by moving around the item, wherein the first unit module associates the first distinctive physical action with a second cell from said plurality of cells by retrieving a current location based on the first motion detection sensor in relation with the grid.

9. The method as in claim 8, further comprising: acquiring an image, adding said image to the selected item structural status; and associating said image to said current location.

10. The method as in claim 3, further comprising: identifying a second point of reference, wherein the second point of reference is the second user initial location in relation to said grid, wherein said initial location is provided by a fourth distinctive physical action on a first cell from said plurality of cells.

11. The method as in claim 10, further comprising: identifying selected item structural status by moving around the item, wherein the second unit module associates the second distinctive physical action with a second cell from said plurality of cells by retrieving a current location based on the first motion detection sensor in relation with the grid.

12. The method as in claim 11, further comprising: acquiring an image, adding said image to the selected item structural status; and associating said image to said current location.

13. The method as in claim 1, wherein said first unit module includes a first integrate close distance data transmitter; wherein said second unit module includes a second integrate close distance data transmitter; wherein the first user and second user validate the current location.

14. The method as in claim 13, wherein the first user and second user validate the current location by approximating the first unit module to the second unit module.

15. The method as in claim 13, wherein the platform evaluates the location of the first unit module with respect to the second unit module.
